(19) United States
(12) Patent Application Publication
(10) Pub. No.: US 2021/0269113 A1
(43) Pub. Date: Sep. 2, 2021

(54) Adjustable Cyclist Support System

(71) Applicant: Samantha Narelle Kirkland, Franklin, NC (US)

(72) Inventor: Samantha Narelle Kirkland, Franklin, NC (US)

(21) Appl. No.: 17/185,043

(22) Filed: Feb. 25, 2021

Related U.S. Application Data
(60) Provisional application No. 62/982,961, filed on Feb. 28, 2020.

(51) Int. Cl. B62J 11/20

(52) U.S. Cl. CPC B62J 11/20

(57) ABSTRACT

An adjustable cyclist support system is provided, including a mounting member and base member for attaching the system to a bicycle. A pivot member is coupled to the base member, the pivot member is detachably coupled to an angled joining member, wherein the joining member is laterally pivotable relative to the pivot member. The angled joining member is coupled to a support member, and the support member is coupled to an angled member. The angled member is coupled to a connector member, and the connector member is detachably coupled to a contact member, wherein the contact member is laterally pivotable relative to the connector member. A contact panel is coupled to the contact member to provide direct support to a cyclist.

### RELATED APPLICATIONS

This application claims priority to and incorporates entirely by reference U.S. Provisional Patent Application Ser. No. 62/982,961 filed on Feb. 28, 2020, entitled “Chest-rest mounted via the handlebars on a racing-type bicycle to ease arm and back strain.”

### FIELD OF INVENTION

This invention relates to a rider-support device for bicycles and, more particularly, to an adjustable support that allows for disengagement when a rider is mounting/dismounting or riding uphill. The present invention also provides for a safety detachment mechanism in the event of a bicycle accident.

### BACKGROUND OF THE INVENTION

Bicycles have been an efficient form of human-powered transportation since the nineteenth century, and they continue to be a popular form of transportation today. In cities and metropolitan areas, many commuters are choosing bicycles in favor of automobiles as an inexpensive, environmentally friendly means of transportation. Similarly, cycling continues to experience growth as a recreational pursuit with numerous cycling disciplines, including road cycling, touring, mountain biking, and gravel riding, as well as professional and amateur racing leagues in each of these disciplines.

In many of these cycling disciplines, a rider will be in a forward leaning stance in order to engage the handlebars for the steering of the bicycle. Many riders will also assume a stance that is as low and close to the handlebars as possible to reduce the surface air of the rider's body to decrease the aerodynamic drag, thus increasing the efficiency and velocity of the bicycle. This form is particularly useful for professional and amateur bike racers for whom aerodynamics is an important consideration.

Indeed, many road bikes feature “drop handlebars” that allow the rider to more easily tuck forward towards the handlebars to achieve a more aerodynamic form. Similarly, many riders install handlebar extensions, known as “aero bars,” that mount close to the center of the handlebar and cantilever out over the front wheel. The aero bars provide a similar means by which a rider may lower their upper body to the handlebars, with the aero bars providing arm rests for the rider to support their wrists and hands.

While these aerodynamic positions are advantageous for efficiency, many cyclists experience back, forearm, wrist, shoulder, and/or hip pain and fatigue during and after long periods hunched forward on a bicycle. This pain or fatigue may be particularly pronounced in older cyclists or in cyclists who ride long distances during a single session. Specifically, research has shown that long periods of riding in a tucked-forward position causes extended flexion of the hip and lumbar spine, which are causes implicated in lower back pain.

Throughout the history of cycling, riders have attempted to relieve the fatigue and pain caused by leaning forward to control the handlebars for the steering of the bicycle. These attempts have included suspending the rider from above, providing a reclined, padded riding position, and different forms of supports to various parts of a rider's hips and/or upper body.

Such approaches, however, have numerous drawbacks, including expense, complexity, and incompatibility with standard road, mountain, touring, and gravel bicycles. Similarly, these attempts often prove cumbersome for mounting and dismounting from a bicycle, and they may prevent a biker from standing upright on the pedals while riding.

Importantly, products that provide a rigid support mechanism that is perpetually and directly in contact between the bicycle frame and the cyclist's body can prove to be particularly dangerous. When a rider is in an accident or a wreck, the rigid support mechanism can transfer the force of the crash directly to the cyclist's body, thus potentially crushing the cyclist's body at the point of contact between the body and the support mechanism.

Accordingly, there exists the need for an adjustable cycling support that does not hinder a cyclist's maneuverability and keeps a cyclist safe in the event of an accident or a wreck.

### SUMMARY OF THE INVENTION

In accordance with one form of the invention, an adjustable cyclist support system is provided. The adjustable cyclist support system comprises a mounting member and a base member for attaching the system to a bicycle, a pivot member coupled to the base member, the pivot member detachably coupled to an angled joining member, the angled joining member coupled to a support member, wherein a first attachment point of the joining member is angled rearward of a second attachment point of the joining member, the support member coupled to an angled member, the angled member coupled to a connector member, wherein a first attachment point of the angled member is angled rearward of a second attachment point of the angled member, the connector member detachably coupled to a contact member, and a contact panel coupled to the contact member.

In accordance with another form of the invention an adjustable cyclist support system is provided. The adjustable cyclist support system comprises a mounting member and base member for attaching the system to a bicycle, the base member is detachably coupled to a support member, the support member is detachably coupled to the contact member, and a contact panel is coupled to the contact member.

In accordance with another form of the invention an adjustable cyclist support system is provided. The adjustable cyclist support system comprises a mounting member and base member for attaching the system to a bicycle, a pivot member is permanently coupled to the base member, the pivot member is detachably coupled to an angled joining member, wherein the joining member is laterally pivotable relative to the pivot member, the angled joining member is permanently coupled to a support member, the support member is permanently coupled to an angled member, the angled member is permanently coupled to a connector member, the connector member detachably is coupled to a contact member, wherein the contact member is laterally pivotable relative to the connector member; and a contact panel is permanently coupled to the contact member.

### BRIEF DESCRIPTION OF THE DRAWINGS

For a fuller understanding of the nature of the present invention, reference should be made to the following detailed description, taken in conjunction with the accompanying drawings in which:

FIG. 1 is a side profile view of a cyclist using the adjustable cyclist support system as installed on a standard bicycle;

FIG. 2 illustrates an exploded profile view of the adjustable cyclist support system, showing the adjustable cyclist support system installed on a standard bicycle;

FIG. 3 illustrates an exploded view of an embodiment of the adjustable cyclist support system.

FIG. 4 is a cross-section view of an embodiment of the adjustable cyclist support system, showing an embodiment of the mounting member installed on a standard bicycle stem; and

FIG. 5 is a side profile view of an embodiment of the adjustable cyclist support system, showing an embodiment of the mounting member installed on a standard bicycle stem.

Like reference numerals refer to like parts throughout the several views of the drawings.

### DETAILED DESCRIPTION

Referring to the several views of the drawings, the adjustable cyclist support system 100 is shown and described herein.

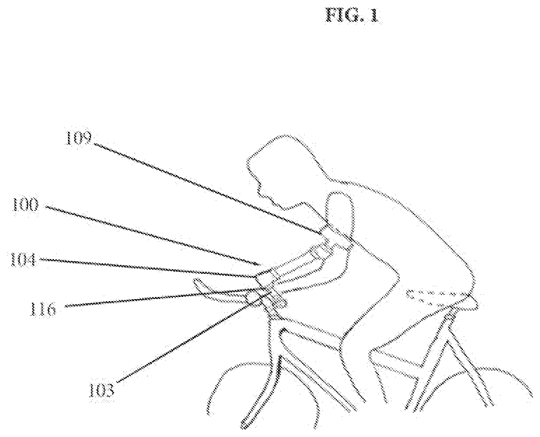

Referring initially to FIG. 1, an adjustable cyclist support system 100 is illustrated attached to a bicycle, showing the adjustable cyclist support system 100 supporting a cyclist while the cyclist is in a position tucked forward over the handlebars of a bicycle. The adjustable cyclist support system 100 may be adjusted in a position so that the contact panel 109 is directly in front of the cyclist's chest so that the cyclist may rest their chest on the contact panel 109, thus easing the flexion on the cyclist's back and hips. Similarly, the adjustable cyclist support system 100 creates a fulcrum that gives the cyclist leverage with which to pull upwards and/or rearwards, allowing the cyclist to employ a separate muscle group.

As can be seen in FIG. 1, the adjustable cyclist support system 100 is mounted on a forward tilting pivot joint 116 that allows for on-the-fly engagement using either hand to pivot the elongate member 118 (and ultimately, the contact panel 109) laterally leftward or rightward to provide an unengaged, ready position when the cyclist stands upright on the pedals during a climb. Specifically, the forward tilting pivot joint 116 is located at the junction between the pivot member 103 and the joining member 104.

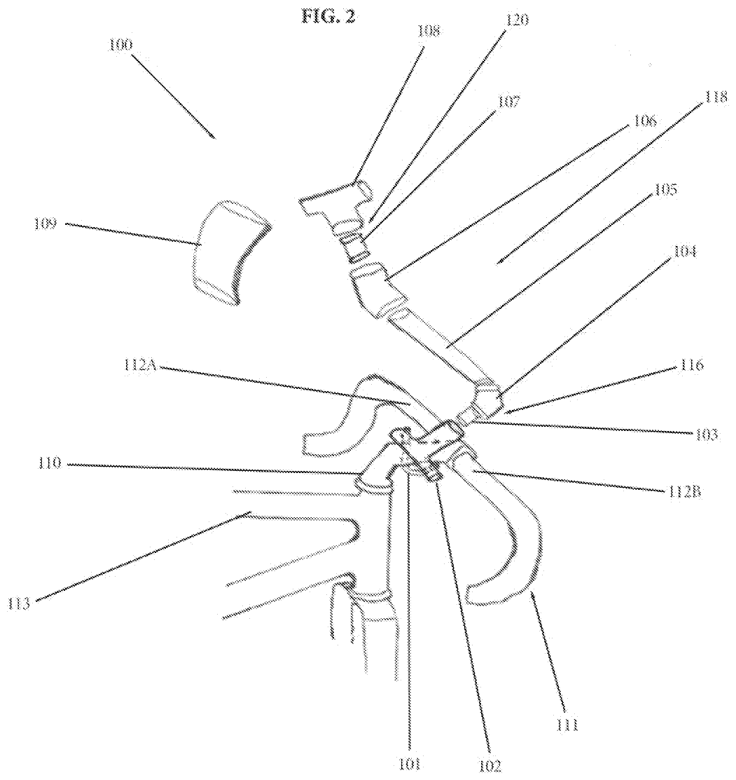

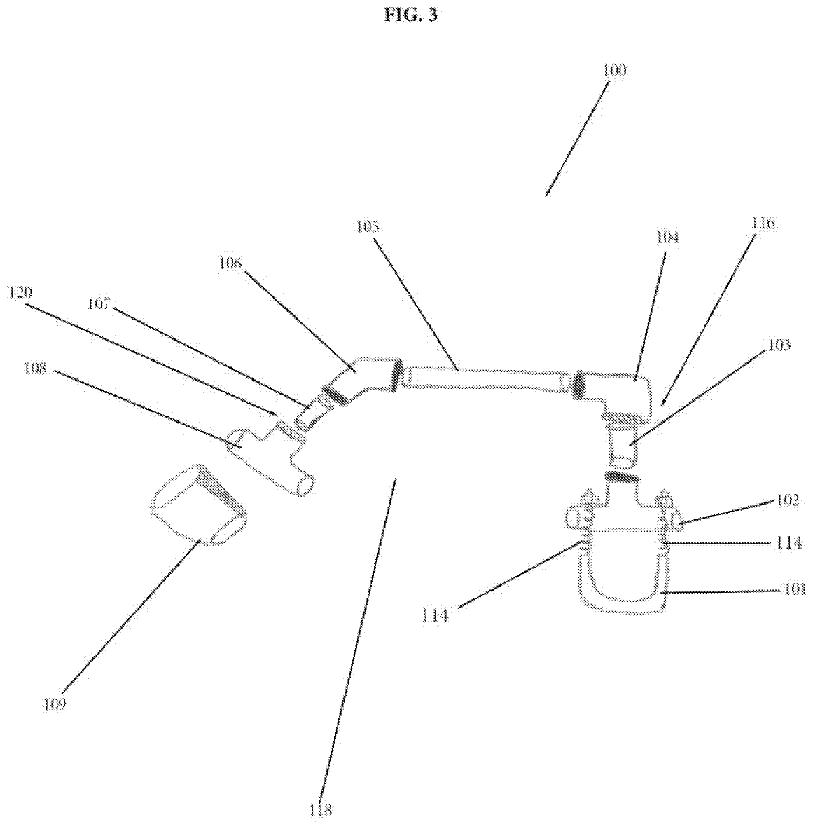

As illustrated in FIGS. 2 and 3, the elongate member 118 is comprised of the joining member 104, support member 105, angled member 106, connector member 107, contact member 108, and contact panel 109, and the elongate member 118 is pivotable at the forward tilting pivot joint 116, located at the junction between the pivot member 103 and joining member 104. When the cyclist mounts or dismounts from the bicycle, the contact panel 109 of adjustable cyclist support system 100 may similarly be pivoted laterally to the left or to the right to displace the adjustable cyclist support system 100 from directly in front of the cyclist. The device pivots along the joint between the pivot member 103 and the joining member 104.

Similarly, the contact panel 109 and contact member 108 may be rotated at the contact member pivot point 120, located at the junction between the contact member 108 and the connector member 107. This rotation allows a cyclist to rotate the contact panel 109 and contact member 108 so that these components may be horizontally oriented, vertically oriented, or otherwise oriented according to the cyclist's preference for engagement with the cyclist's chest.

FIG. 2 illustrates an exploded view of an embodiment of the adjustable cyclist support system 100, mounted onto a standard bicycle. The adjustable cyclist support system 100 is attached to the bicycle via the mounting member 101, allowing the adjustable cyclist support system 100 to be removably attached to the bicycle. The inner surface of the mounting member 101 may be cushioned with rubber or similar nonslip adherence material to prevent the adjustable cyclist support system from migrating along the attachment surface and to provide protection to the bicycle surface. In one embodiment, the mounting member 101 may be a u-shaped component sized to fit around the bicycle top tube 113, stem 110, or handlebar 111. In another embodiment, the mounting member 101 may be complementary curved clamp plates, which utilize a tightening bolt and nut assembly, a spring mechanism, or other similar mechanism for securing the curved clamp plates around the circular exterior of a bicycle stem or a bicycle handlebar. In another embodiment, the mounting member 101 may comprise a circular base plate sized to fit the top surface of a bicycle stem 110, a hole extending from the top surface of the base plate through the bottom surface of the base plate, and a threaded locking mechanism sized to be placed through the hole of the base plate and thread into a female receiver in the top surface of the bicycle stem 110. In another embodiment, the adjustable cyclist support system 100 is attached at the rearmost point of the bicycle stem 110, or alternatively, as close to the rearmost point of the bicycle stem 110 as practically possible for the specific bicycle configuration. It will be appreciated to one of ordinary skill in the art that the angles and configuration of the mounting member 101 and base member 102 may be varied and adapted to fit the different sizes, angles, and shapes of the stems and/or handlebars of various bicycle manufacturers.

As shown in FIG. 2, in one embodiment, the adjustable cyclist support system 100 is attached at the stem 110 or near the center point of the bicycle handlebar assembly 111 between the left handle 112A and the right handle 112B. The mounting member 101 is attached around the stem 110 and/or handlebars 111 of the bicycle and secured to the base member 102. The pivot member 103 is permanently attached to the base member 102 at the base of the pivot member 103 and the uppermost portion of the base member 102. Such permanent attachment may be via cement, glue, or other bonded attachment means, or alternatively, via frictional, threaded, or other similar locking mechanism.

The pivot member 103 is removably attached to the joining member 104 via frictional or similar joining mechanism, such as a threaded attachment. Such joining means allows the adjustable cyclist support system 100 to pivot at this point to allow the contact panel 109 to be laterally rotated to the left or right so that the contact panel 109 is disengaged from the cyclist's chest. The left or right lateral rotation allows the contact panel 109 to be disengaged from the cyclist's chest when standing upright on the pedals or when mounting/dismounting from the bicycle. When the contact panel 109 of adjustable cyclist support system 100 is engaged with the cyclist's chest, the position is maintained via the pressure from the cyclist's chest. When combined with the forward tilted base accomplished by angled joining member 104, the adjustable cyclist support system 100 may separate (at the joint between the pivot member 103 and joining member 104) during forceful collisions that may otherwise injure the cyclist.

In one embodiment, the uppermost portion of the joining member 104 is permanently attached to the lowermost portion of the support member 105. The uppermost portion of the support member 105 is permanently attached to lower portion of the angled member 106. The upper portion of the angled member is permanently attached to the lower portion of the connector member 107. In one embodiment, the angled member 106 may have an angle of around 45 degrees to allow the contact panel 109 to be properly positioned to engage the cyclist's chest, as necessitated by the frame shape of the particular bicycle and the orientation of the cyclist.

It will be appreciated by one of ordinary skill in the art that the support member 105 may alternatively be removably attached to the angled member 106 and joining member 104 in order that a cyclist may utilize support members 105 of different lengths to fit differently sized bicycles or differently sized cyclists.

The uppermost potion of the connector member 107 is removably attached to the lowermost portion of the contact member 108 via frictional or similar joining mechanism, such as a threaded attachment. Such joining means allows the contact member 108 (and in turn, the contact panel 109) to be axially pivoted at this connection point, and thus allows the cyclist to position the contact panel 109 to comfortably contact the cyclist's chest.

The contact panel 109 may be a padded panel composed of rubber, memory foam, enclosed gel, or similar supportive material that optionally may be enclosed in a durable fabric covering, providing a comfortable platform on which a cyclist may rest their chest when the adjustable cyclist support system 100 is engaged.

Importantly, and as can be seen in FIGS. 1 and 2, the joining member 104 is an angled connector. In one embodiment, the angle of joining member 104 may be around ninety degrees or less, as necessitated by the frame shape of the particular bicycle and the orientation of the cyclist. The angling of the joining member 104 is necessary to ensure that the contact panel 109 is properly oriented to contact the cyclist's chest while maintaining the forward-tilted bias of the base components.

It will be appreciated by one of ordinary skill in the art that different angles in the joining member 104 may be used to align the contact panel 109 with the chest of the cyclist, without departing from the spirit or goals of the invention.

The uppermost portion of the pivot member 103 is oriented substantially forward-facing relative to the bicycle's direction of travel. This orientation works in concert with the angled and removably attached nature of the joint between joining member 104 and pivot member 103 so that this joint is resilient to support the relatively static force of supporting a cyclist's chest, while the joint will detach the joining member 104 from the pivot member 103 in the event of an accident or crash. Without such a distinguishing feature, the force of a bicycle crash would be transferred directly to the cyclist's chest at the contact panel 109 of the adjustable cyclist support system 100.

Importantly, and as can be seen in FIGS. 1 and 2, the attachment point of the adjustable cyclist support system 100 allows the cyclist's weight to be concentrated on the handlebars 111 and/or stem 110 of the bicycle. This placement minimizes the effects on the balance or steering of the bicycle.

The members described herein may be composed from any number of strong, lightweight materials such as carbon fiber, graphene, nanene, or plastic/thermoplastic-type polymers.

Referring to FIG. 3, an embodiment of the adjustable cyclist support system 100 is shown in which the mounting member 101 is a u-shaped component with locking components 114 on the upper terminal end of mounting member 101. When attached to a bicycle, the locking components 114 are engaged with the base member 102 and may be tightened via bolts, snaps, or other similar locking mechanism.

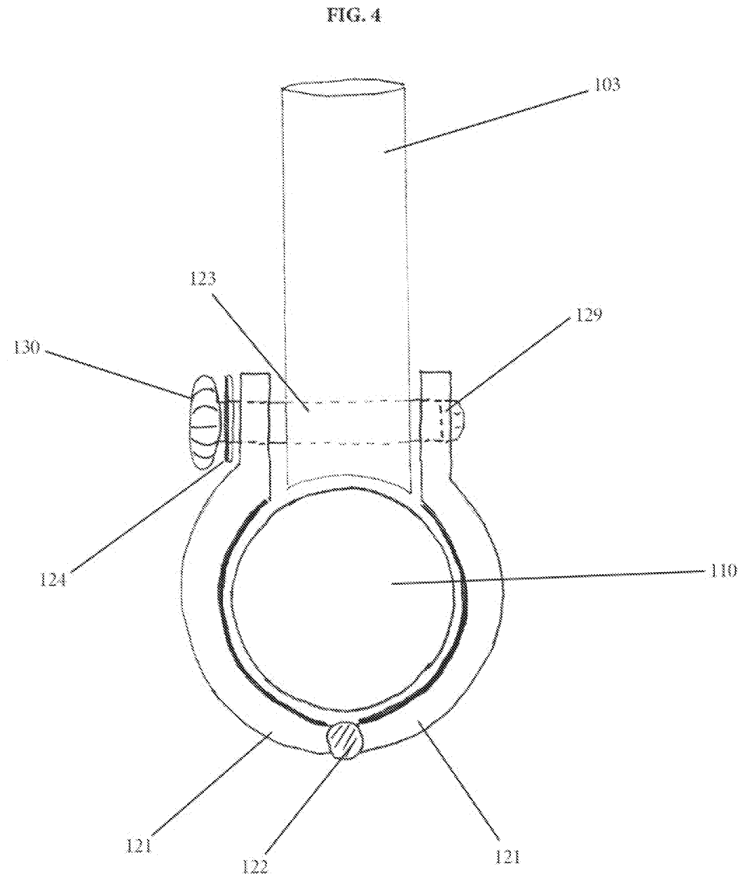

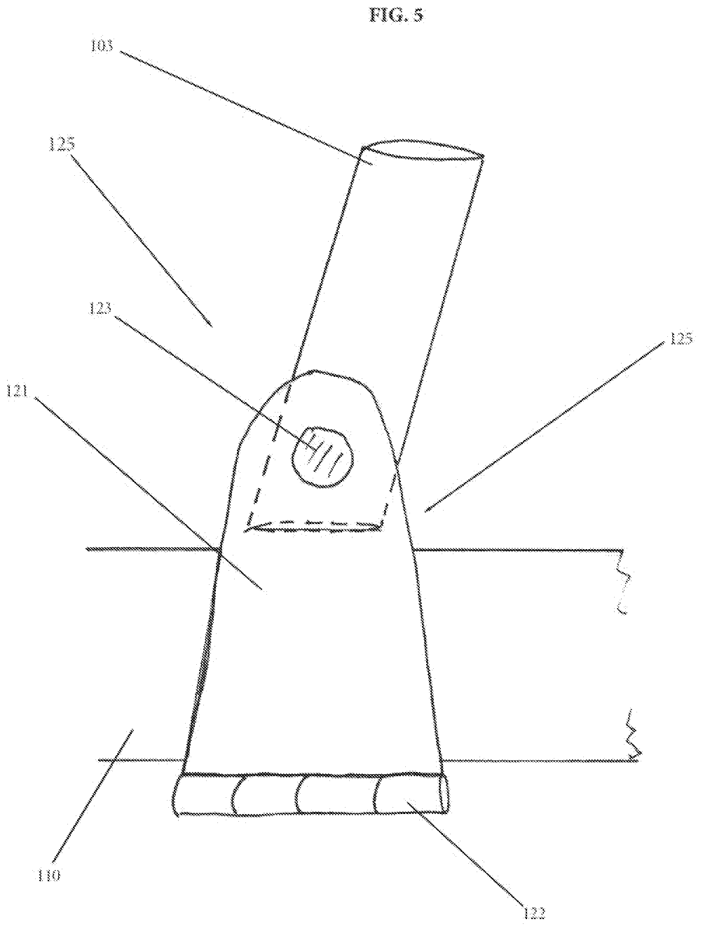

Referring to FIGS. 4 and 5, an embodiment of the mounting member 101 is shown in which the mounting member 101 is attached to the bicycle stem 110 of a standard bicycle and provides a pivoting connection for the base member 102 or pivot member 103 to be directly connected to the mounting member 101 and be selectively pivotable relative to the mounting member 101. FIG. 4 illustrates a cross-sectional view of this embodiment and FIG. 5 illustrates a profile view of this embodiment. Hash marks in FIG. 4 illustrate the tube-bolt 128 in the interior of pivot member 103. Hash marks in FIG. 5 illustrate the pivot member 103 and tube-bolt 128 behind the curved tube clamp 125.

In this embodiment, a curved tube clamp 125 is sized and configured to be secured around a standard bicycle stem 110, or it may be adapted to fit around bicycle stems 110 of different bicycle manufacturers. The curved tube clamp 125 may be composed of curved tube clamp members 121 that are connected via a tube clamp hinge 122, allowing the curved tube clamp 125 to be opened to fit around a tubular bicycle stem 110. One of the curved tube clamp members 121 contains a bolt-receiving hole 126 at its terminal end, and the other tube clamp member 121 contains a female receiver 129 for receipt of the threaded end of tube-bolt 128. A washer 130 may also be sized to fit onto tube-bolt 128 for securing the tube-bolt 128 to the curved tube clamp 125.

In this embodiment, base member 102 or pivot member 103 contains holes similarly sized for receipt of tube-bolt 128, in which tube-bolt 128 passes through the bolt-receiving hole 126 of the curved tube clamp 125, passes through the base member 102 or pivot member 103 holes, and is inserted into female receiver 129 of curved tube clamp 125, where it may be tightened via the threaded end of the tube-bolt 128 and the curved receiver of female receiver 129.

Tightening of tube-bolt 128 pulls the terminal ends of the curved tube clamp members 121 together, thus securing the curved tube clamp 125 to the bicycle stem 110. This tightening of tube-bolt 128 additionally tightens the terminal ends of the curved tube clamp members 121 against the sides of pivot member 103 (or base member 102 in alternative embodiments), thus securing the pivot member 103 in the cyclist's desired position. As discussed with regards to FIG. 5 below, this loosening and tightening of tube-bolt 128 allows the adjustable cyclist support system 100 to be positioned to fit an individual cyclist's desired configuration.

FIG. 5 illustrates a profile view of the curved tube clamp 125 attached to a bicycle stem 110. Tube-bolt 128 is seen providing a pivot point along which the pivot member 103 (or in alternative embodiments, base member 102) may pivot to adjust the positioning of the pivot member 103, which in turn adjusts the positioning of the joining member 104, support member 105, angled member 106, connector member 107, contact member 108, and contact panel 109. This pivoting adjustment ultimately assists in allowing a cyclist to adjust the point at which the contact panel 109 contacts the cyclist's chest. This adjustment is useful in allowing cyclists of different heights to adjust the contact panel 109 to fit comfortably at their relative heights. Additionally, it allows a cyclist to adjust the positioning of the contact panel 109 where, for example, a cyclist may alternate between riding in a more upright position and in a tucked position.

The tube-bolt 128 may have a hand-adjustable tube-bolt head 130, that allows a user to loosen the tube-bolt 128 as it is seated in female receiver 129. When the tube-bolt 128 is loosened, the cyclist may adjust the pivot member 103 along the pivot point created at the tube-bolt 128. Once a desired position is reached, the cyclist may tighten the tube-bolt 128 to lock the position of pivot member 103. In another embodiment, the adjustable cyclist support system 100 is attached at the rearmost point of the bicycle stem 110, or alternatively, as close to the rearmost point of the bicycle stem 110 as practically possible for the specific bicycle configuration.

It will be appreciated by one of skill in the art that alternative attachment means, such as quick-release cams, may be used for securing the curved tube clamp 125 to a bicycle stem 110 without departing from the spirit and goals of the invention.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. For brevity and/or clarity, well-known functions or constructions may not be described in detail herein.

The term “exemplary” is used herein to mean serving as an example, instance, or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner.

The terms “for example” and “such as” mean “by way of example and not of limitation.” The subject matter described herein is provided by way of illustration for the purposes of teaching, suggesting, and describing, and not limiting or restricting. Combinations and alternatives to the illustrated embodiments are contemplated, described herein, and set forth in the claims.

For convenience of discussion herein, when there is more than one of a component, that component may be referred to herein either collectively or singularly by the singular reference numeral unless expressly stated otherwise or the context clearly indicates otherwise. For example, components N (plural) or component N (singular) may be used unless a specific component is intended. Also, the singular forms “a,” “an,” and “the” are intended to include the plural forms as well, unless expressly stated otherwise or the context indicates otherwise.

It will be further understood that the terms “includes,” “comprises,” “including,” and/or “comprising” specify the presence of stated features, steps, operations, elements, and/or components, but do not preclude the presence or addition of one or more other features, steps, operations, elements, components, and/or groups thereof unless explicitly stated otherwise or the context clearly requires otherwise. The terms “includes,” “has” or “having” or variations in form thereof are intended to be inclusive in a manner similar to the term “comprises” as that term is interpreted when employed as a transitional word in a claim.

It will be understood that when a component is referred to as being “connected” or “coupled” to another component, it can be directly connected or coupled or coupled by one or more intervening components unless expressly stated otherwise or the context clearly indicates otherwise.

The term “and/or” includes any and all combinations of one or more of the associated listed items. As used herein, phrases such as “between X and Y” and “between about X and Y” should be interpreted to include X and Y unless expressly stated otherwise or the context clearly indicates otherwise.

Terms such as “about”, “approximately”, and “substantially” are relative terms and indicate that, although two values may not be identical, their difference is such that the apparatus or method still provides the indicated or desired result, or that the operation of a device or method is not adversely affected to the point where it cannot perform its intended purpose. As an example, and not as a limitation, if a height of “approximately X inches” is recited, a lower or higher height is still “approximately X inches” if the desired function can still be performed or the desired result can still be achieved.

While the terms vertical, horizontal, upper, lower, bottom, top and the like may be used herein, it is to be understood that these terms are used for ease in referencing the drawing and, unless otherwise indicated or required by context, does not denote a required orientation.

The different advantages and benefits disclosed and/or provided by the implementation(s) disclosed herein may be used individually or in combination with one, some or possibly even all of the other benefits. Furthermore, not every implementation, nor every component of an implementation, is necessarily required to obtain, or necessarily required to provide, one or more of the advantages and benefits of the implementation.

Conditional language, such as, among others, “can”, “could”, “might”, or “may”, unless specifically stated otherwise, or otherwise understood within the context as used, is generally intended to convey that certain embodiments preferably or optionally include certain features, elements and/or steps, while some other embodiments optionally do not include those certain features, elements and/or steps. Thus, such conditional language indicates, in general, that those features, elements and/or step may not be required for every implementation or embodiment.

Those skilled in the art will recognize that modifications may be made to the implementation(s) disclosed herein without departing from the scope or spirit of the claimed subject matter. The subject matter described above is provided by way of illustration only and should not be construed as limiting. Furthermore, the claimed subject matter is not limited to implementations that solve any or all disadvantages noted in any part of this disclosure. Various modifications and changes may be made to the subject matter described herein without following the exemplary embodiments and applications illustrated and described, and without departing from the spirit and scope of the following claims.

What has been described above includes examples of aspects of the claimed subject matter. It is, of course, not possible to describe every conceivable combination of components or methodologies for purposes of describing the claimed subject matter, but one of ordinary skill in the art may recognize that further combinations and permutations of the disclosed subject matter are possible. Accordingly, the disclosed subject matter is intended to embrace all such alterations, modifications and variations that fall within the spirit and scope of the appended claims.

Although the subject matter presented herein has been described in language specific to components used therein, it is to be understood that the appended claims are not necessarily limited to the specific component or characteristic thereof described herein. Rather, the specific components and characteristics thereof are disclosed as example forms of implementing the claims.

From the foregoing description of various embodiments of the invention, it will be apparent that modifications may be made therein. It is understood that these embodiments of the invention are exemplifications of the invention only and that the invention is not limited thereto.

1. An adjustable cyclist support system for use in combination with a bicycle, the adjustable cyclist support system comprising:
a mounting member coupled to a base member;
a pivot member coupled to the base member;
the pivot member detachably coupled to an angled joining member;
the angled joining member coupled to a support member, wherein a first attachment point of the joining member is angled rearward of a second attachment point of the joining member;
the support member coupled to an angled member;
the angled member coupled to a connector member, wherein a first attachment point of the angled member is angled rearward of a second attachment point of the angled member;
the connector member detachably coupled to a contact member; and
a contact panel coupled to the contact member.

2. The adjustable cyclist support system of claim 1, wherein the joining member is laterally pivotable relative to the pivot member.

3. The adjustable cyclist support system of claim 1, wherein the contact member is laterally pivotable relative to the connection member.

4. The adjustable cyclist support system of claim 1, wherein the angling of joining member is about ninety degrees.

5. The adjustable cyclist support system of claim 1, wherein the angling of the joining member is less than about ninety degrees.

6. The adjustable cyclist support system of claim 1, wherein the angling of the angled member is about forty-five degrees.

7. The adjustable cyclist support system of claim 1, wherein the angling of the angled member is less than about forty-five degrees.

8. The adjustable cyclist support system of claim 1, wherein:
the mounting member comprises:
a u-shaped bolt having threaded ends; and
threaded nuts sized for threading onto the threaded ends of the u-shaped bolt; and
the base member containing holes sized for receipt of the threaded ends of the mounting member.

9. The adjustable cyclist support system of claim 1, wherein the contact member, connector member, angled member, support member, joining member, pivot member, and base member are composed of carbon fiber.

10. The adjustable cyclist support system of claim 1, wherein the contact member, connector member, angled member, support member, joining member, pivot member, and base member are composed of a plastic polymer.

11. The adjustable cyclist support system of claim 1, wherein the contact member, connector member, angled member, support member, joining member, pivot member, and base member are composed of graphene.

12. The adjustable cyclist support system of claim 1, wherein:
the mounting member comprises:
a curved tube clamp sized to fit a bicycle stem;
the curved tube clamp having a first terminal end and a second terminal end;
the first terminal end of the curved tube clamp containing a receiver hole;
the second terminal end of the curved tube clamp containing a female threaded receptacle;
a threaded connection mechanism sized to fit the receiver hole; and
the threaded connection mechanism sized to engage the female threaded receptacle;
the base member comprises:
a first terminal end and a second terminal end;
the first terminal end of the base member being permanently coupled to the pivot member; and
the second terminal end containing a plurality of holes sized for receipt of the threaded connection mechanism.

13. An adjustable cyclist support system for use in combination with a bicycle, the adjustable cyclist support system comprising:
a mounting member coupled to a base member;
the base member detachably coupled to a support member;
the support member detachably coupled to the contact member; and
a contact panel coupled to the contact member.

14. The adjustable cyclist support system of claim 13, wherein a first attachment point of the support member is angled rearwards at about ninety degrees.

15. The adjustable cyclist support system of claim 13, wherein a first attachment point of the support member is angled rearwards at less than about ninety degrees.

16. The adjustable cyclist support system of claim 13 wherein a first attachment point of the support member is angled rearwards at about forty-five degrees.

17. An adjustable cyclist support system for use in combination with a bicycle, the adjustable cyclist support system comprising:
a mounting member coupled to a base member;
a pivot member permanently coupled to the base member;
the pivot member detachably coupled to an angled joining member, wherein the joining member is laterally pivotable relative to the pivot member;
the angled joining member permanently coupled to a support member;
the support member permanently coupled to an angled member;
the angled member permanently coupled to a connector member;
the connector member detachably coupled to a contact member, wherein the contact member is laterally pivotable relative to the connector member; and
a contact panel permanently coupled to the contact member.

18. The adjustable cyclist support system of claim 17, wherein the angling of the joining member is about ninety degrees.

19. The adjustable cyclist support system of claim 17, wherein the angling of the angled member is about forty-five degrees.

20. The adjustable cyclist support system of claim 17, wherein:
the mounting member comprises:
a curved tube clamp sized to fit a bicycle stem;
the curved tube clamp having a first terminal end and a second terminal end;
the first terminal end of the curved tube clamp containing a receiver hole;
the second terminal end of the curved tube clamp containing a female threaded receptacle;
a threaded connection mechanism sized to fit the receiver hole; and
the threaded connection mechanism sized to engage the female threaded receptacle;
the base member comprises;
a first terminal end and a second terminal end;
the first terminal end of the base member being permanently coupled to the pivot member; and
the second terminal end containing a plurality of holes sized for receipt of the threaded connection mechanism.
